(19) United States
(12) Patent Application Publication
(10) Pub. No.: US 2020/0171617 A1
(43) Pub. Date: Jun. 4, 2020

(54) METHOD AND TOOL FOR REMOVING A COATING FROM A SUBSTRATE

(71) Applicant: GUEHRING KG, Albstadt (DE)

(72) Inventor: Peter LUTZ, Markt Rettenbach (DE)

(73) Assignee: GUEHRING KG, Albstadt (DE)

(21) Appl. No.: 16/692,131

(22) Filed: Nov. 22, 2019

Related U.S. Application Data
(63) Continuation of application No. PCT/EP2017/062389, filed on May 23, 2017.

(51) Int. Cl. B24B 27/033; B23B 27/08

(52) U.S. Cl. CPC B24B 27/033; B23B 27/08

(57) ABSTRACT

The present invention relates to a method and a tool for removing a partial region of a coating from a substrate, in which the partial region to be removed is removed by a machining process in such a way that an undercutting of the partial region of the coating that is to be removed takes place. For the undercutting of the partial region of the coating that is to be removed, at least one machining tool that is rotating relative to the substrate about an axis of rotation is moved relative to the substrate along a direction of advancement that runs parallel to a surface having the coating, wherein a layer of the substrate that is directly adjacent to the coating is also removed together with the coating. Considered in the direction of advancement, the tool thereby penetrates deeper into the substrate than into the coating to be removed.

The present invention relates to a method and a tool for removing a partial region of a coating from a substrate, in particular in a partial region of a cylinder of an engine block of an internal combustion engine.

### STATE OF THE ART

The starting point of the invention is a substrate provided with a coating in some regions. The substrate can, for example, be on an inner surface of a cylinder wall of a crankcase of an internal combustion engine. Accordingly, it can be a substrate made of aluminum, an aluminum alloy or another light metal alloy. A coating is applied to the substrate in a thermal spray process. The thermal spray process can be, for example, wire arc spraying (LDS). In wire arc spraying, a spray material is blown onto the substrate, for example, a cylinder wall, with the aid of an arc and an atomizing gas.

A coating applied by thermal spraying, in particular a cylinder surface coating, measures only a few tenths of a millimeter and has a very high hardness. A machining/reworking of a substrate coated in this way, in particular a crankcase region, is therefore associated with very high tool wear. Nevertheless, certain partial regions of a crankcase must be machined after coating the cylinder surfaces.

DE 10 2009 051 262 A1 discloses a method for producing a thermally sprayed cylinder working surface for an internal combustion engine, wherein a coating is applied to an inside of a cylinder by a thermal spray process. The coating is machined by a chipping process and then by a high-pressure water jet with a pressure of up to 1,000 bar.

A generic method is described in DE 10 2011 078 591 A1.

EP 1 820 874 A2, DE 10 2004 038 174 A1 and WO 00/37789 A1 show methods for removing a hardened coating from a cylinder working surface, in which the coating is carried out starting from the front of the coating into the substrate in order to introduce a chamfer into the coating and adjacent substrate regions.

DE 10 2010 035 641 A1 describes a honing process in which only part of the coating is removed in order to expose the pores present in the coating for the purpose of oil retention. A complete removal of the coating is not mentioned there.

It is the object of the invention to provide a method and a tool for removing a partial region of a coating applied by thermal spraying from a substrate, in which the tool wear is reduced.

### DISCLOSURE OF THE INVENTION

The object is achieved by the features of claim 1 and in particular by a method in which the partial region to be removed is removed by a machining process in such a way that the partial region of the coating to be removed is undercut, wherein in order to undercut the partial region of the coating to be removed, at least one machining tool rotating relative to the substrate about an axis of rotation is moved relative to the substrate along a direction of advancement which runs parallel to a surface having the coating, wherein together with the coating, a substrate layer directly adjacent to the coating is also removed and the tool, considered in the direction of advancement, penetrates deeper into the substrate than into the coating to be removed, that is, with increasing radial distance from the axis of rotation, the tool penetrates deeper or further into the workpiece, considered in the direction of advancement, and thus undercuts the coating with a radially outer partial section of a cutting edge of the tool. In this case, undercutting means that it is not the hardened coating to be removed that is itself machined, but rather a chipping process that removes the material region of the workpiece on which the coating is applied. Since this material region has a lower hardness, the coating can be removed with relatively little effort at least in some regions. The tool thus removes the coating to be removed laterally. Lateral removal is understood to mean that the removal takes place in a transverse direction to a surface orthogonal of the coated surface, specifically in the direction of advancement.

A cutting edge of the tool is protected by a relatively soft substrate layer, for example, an aluminum layer, flowing over it during machining, so that contact with the hard coating material is reduced or avoided. The thickness of the removed substrate layer may only be a few tenths of a millimeter.

When the substrate is, for example, a cylinder wall of a cylinder of a crankcase, material is removed essentially in the axial direction of the cylinder.

At the beginning of the removal process, it can be necessary to make a puncture through the coating, after which the further processing takes place in the softer carrier material of the coating. For this purpose, the removal tool generally has a cutting direction of the cutting edge that is angled from the radius of a rotating working movement in order to be able to produce an undercut of the coating.

Due to the undercut, the tool is located at a working angle to the coating, by which the wear of the tool is reduced.

Advantageous refinements and developments of the invention can be found in the claims, the description and the drawings.

The machining tool is advantageously a cutting insert.

The direction of advancement advantageously runs parallel to the axis of rotation.

The tool can, for example, be held on a rotating spindle. Alternatively, the tool can also be mounted in a non-rotating manner and the substrate is rotated.

The tool is advantageously held on a rotating spindle which can be adjusted along the direction of advancement.

The tool is advantageously held in such a way that a cutting edge of the tool provided for removal the coating runs obliquely to the direction of advancement, in particular at an angle of 30° to 60°, preferably of 40° to 50°. A free surface angle of the cutting edge can be, for example, 10° to 25°, preferably 15° to 20° and in particular 16° to 17°.

The method according to the invention advantageously comprises the generation of a groove free of undercuts, in particular an annular groove, in a partial section of the partial region of the coating to be removed. The partial section serves in particular to insert the tool into a starting position before performing the lateral removal of the coating by undercutting the coating. The groove is generated in particular using a tool other Lhan Llie tool provided for the lateral removal of the coating, in particular by means of a preferably rotating grinding tool. The groove preferably extends through the layer to be removed and in particular into the substrate. The partial section into which the groove is introduced is generally substantially smaller than the entire partial region of the coating to be removed, and is preferably just large enough that the tool is received in the groove in order to reach into a starting position suitable for undercutting the coating. The surface of the groove is in particular less than 50%, advantageously less than 25%, preferably less than 10% and particularly preferably less than 5% of the surface of the partial region of the coating to be removed. This ensures that the tool wear of the undercutting tool is as low as possible.

If the substrate is a cylinder wall of a cylinder of a crankcase, the partial region of the coating to be removed can be provided in an end section, in particular an end section of the cylinder on the crankshaft side, in particular in the region of a honing clearance. With the post-machining according to the invention, a so-called honing clearance, that is, a ring-like recess, can be machined or generated, or at least the coating can be removed prior to generating the honing clearance. After the honing clearance has been generated, the coating applied to the first partial region can be honed. The honing clearance is required so that a honing tool can taper off cleanly.

In a subordinate aspect, a chipping tool, in particular a grinding tool, is proposed for performing the aforementioned method. The tool comprises a tool holder fastened to a spindle, which tool holder has at least one, in particular two, radially opposite cutting edges, preferably cutting edges arranged on cutting inserts, which cutting edges are radially adjustable. The cutting edges can be arranged in the direction of the spindle or on a side facing away from the spindle on the tool holder in order to enable the substrate layer to be milled off by a pulling or pushing movement of the spindle.

A tool arrangement suitable for performing the method according to the invention thus comprises a tool holder having an axis of rotation and at least one machining tool having a cutting edge, which machining tool is fixedly or detachably fastened to the tool holder, wherein the cutting edge is spaced apart from the axis of rotation, and wherein a straight line running along the cutting edge includes an acute angle with the axis of rotation so that the distance of a point on the cutting edge from an imaginary end face running orthogonal to the axis of rotation increases with increasing distance of this point from the axis of rotation. The angle between the cutting edge and the axis of rotation is in particular between 30° and 60°, preferably between 40° and 50°. This tool arrangement enables an efficient undercut of the hardened substrate with a low wear rate and a long service life of the tool arrangement. A radial adjustment of the cutting edges after the spindle has been retracted into the interior of a hollow cylinder, for example, into a motor housing cylinder sleeve, allows, in the interior, the cutting edges to be extended and the hard cylinder wall to be undercut.

The method according to the invention and a tool holder are described below by way of example with reference to the drawings.

### DRAWINGS

Further advantages result from the present description of the drawing. Exemplary embodiments of the invention are illustrated in the drawing. The drawing, the description and the claims contain numerous features in combination. The person skilled in the art will expediently also consider the features individually and combine them into useful further combinations.

Shown are:

FIGS. 1 to 7 show sectional views of a workpiece to be machined and the necessary tools and explain the sequence of the method over time;

FIG. 8 shows different views of a tool holder with two tools according to a first embodiment;

FIG. 9 shows various views of the tool holder of FIG. 8;

FIG. 10 shows different views of a tool holder with two tools according to a second embodiment;

FIG. 11 shows a sectional view of a tool during the removal of a coating of a substrate;

FIG. 12 shows an enlarged section of the sectional view of FIG. 11.

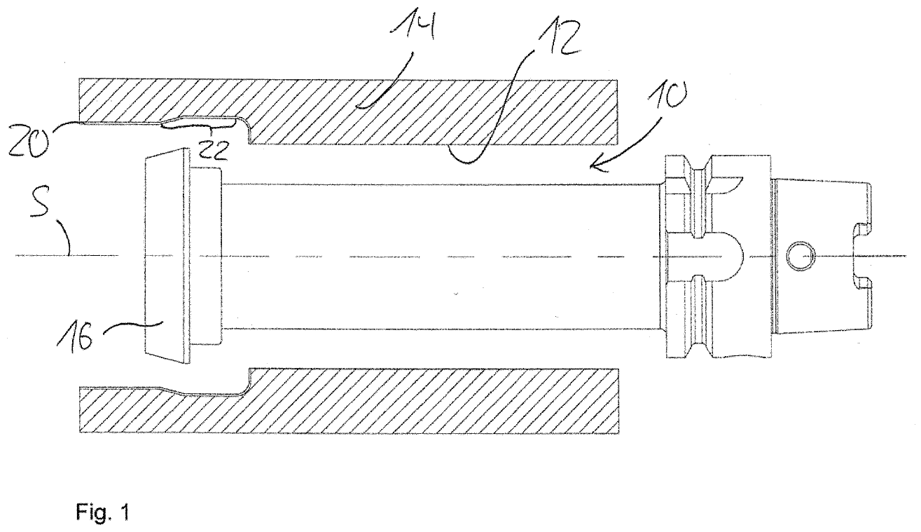

An exemplary sequence of the method according to the invention is illustrated in FIGS. 1 to 7.

In the figures, identical or similar components are numbered with the same reference numerals.

The removal of a partial region 22 of a hard coating 20, which was applied by a thermal spray process on a soft substrate, namely an inner surface or cylinder wall 12 of a cylinder 10 of an aluminum crankcase 14 of an internal combustion engine, is explained by way of example.

In step 1 (FIG. 1), a rotatable, in the embodiment conical, grinding tool 16 is inserted into the cylinder 10 a central position.

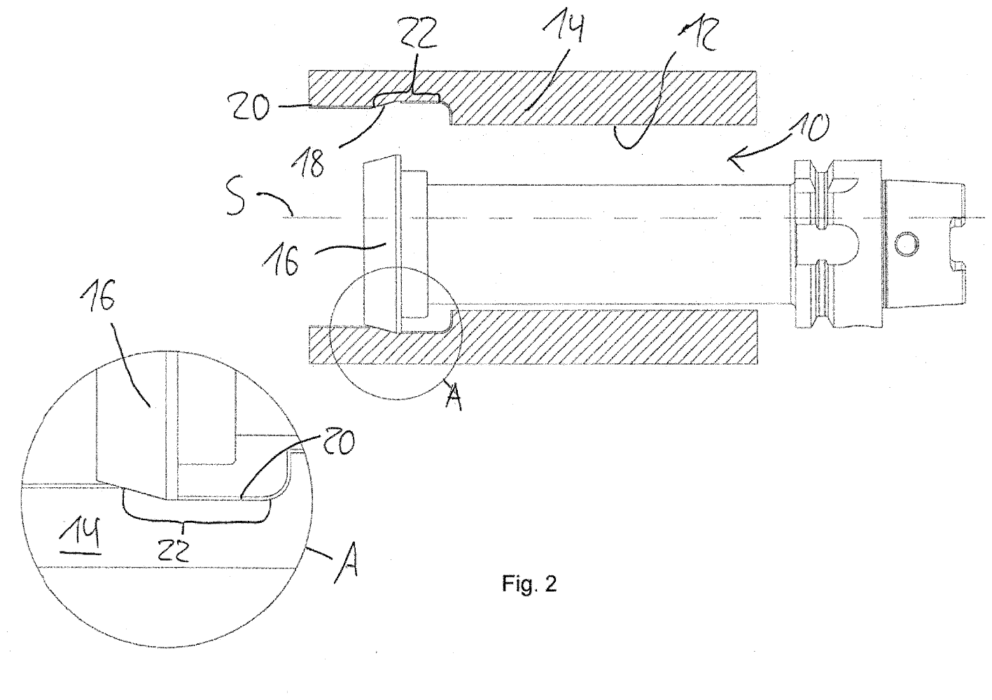

In step 2 (FIG. 2), the rotating grinding tool 16 is guided along an increasingly circular path along the coated cylinder wall 12 in order to grind an annular groove 18 or chamfer into the coating 20 in the radial direction. Tool wear is limited since the partial section of the annular groove 18 to be ground is small compared to a partial region 22 of the coating 20 to be removed.

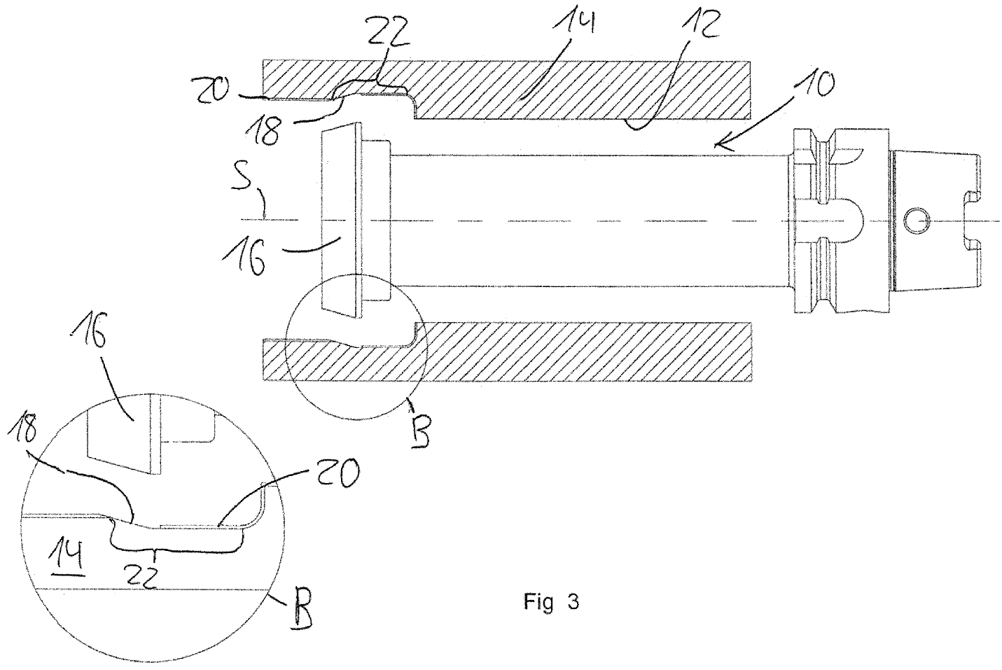

In step 3 (FIG. 3), the rotatable grinding tool 16 is moved back into the central position and withdrawn from the cylinder 10.

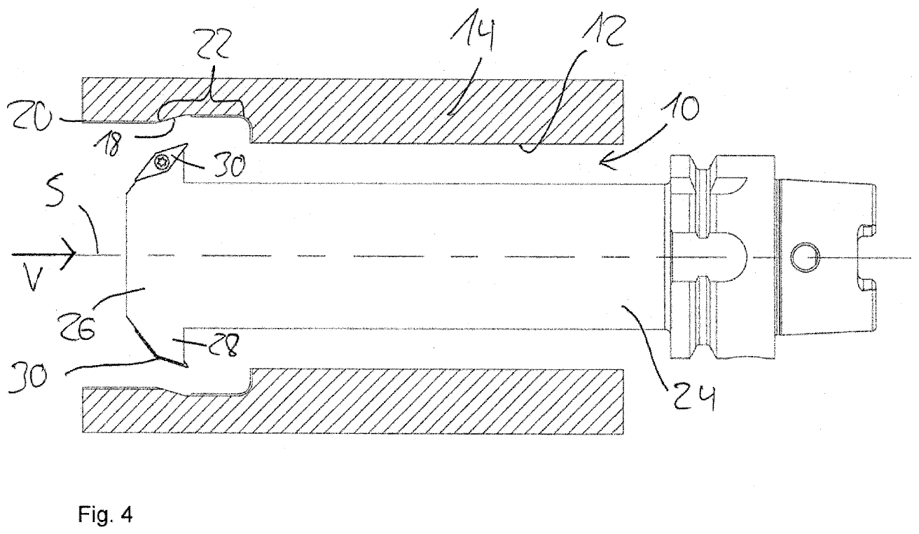

In step 4 (FIG. 4), a tool holder 26 fastened to a spindle 24 is retracted into the cylinder 10 against a direction of advancement V. The spindle 24 is adjustable in and opposite to the direction of advancement V and rotatable about an axis of rotation corresponding to the axis of symmetry S of the cylinder 10.

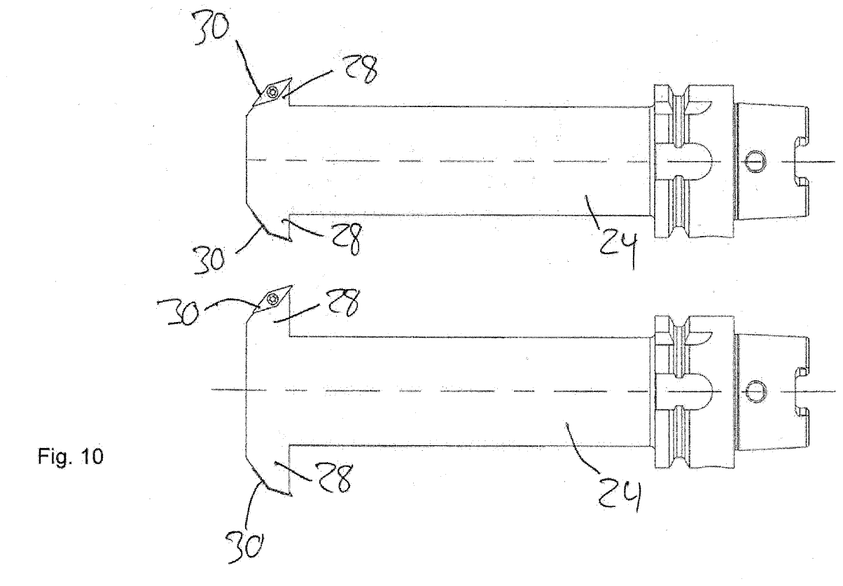

Two opposing, radially adjustable clamping jaws 28 are provided on one end or front face of the tool holder 26, in which clamping jaws a respective cutting insert 30 is held as a machining tool. The tool holder 26 is illustrated again in FIG. 10 with the clamping jaws 28 retracted (above) and extended (below).

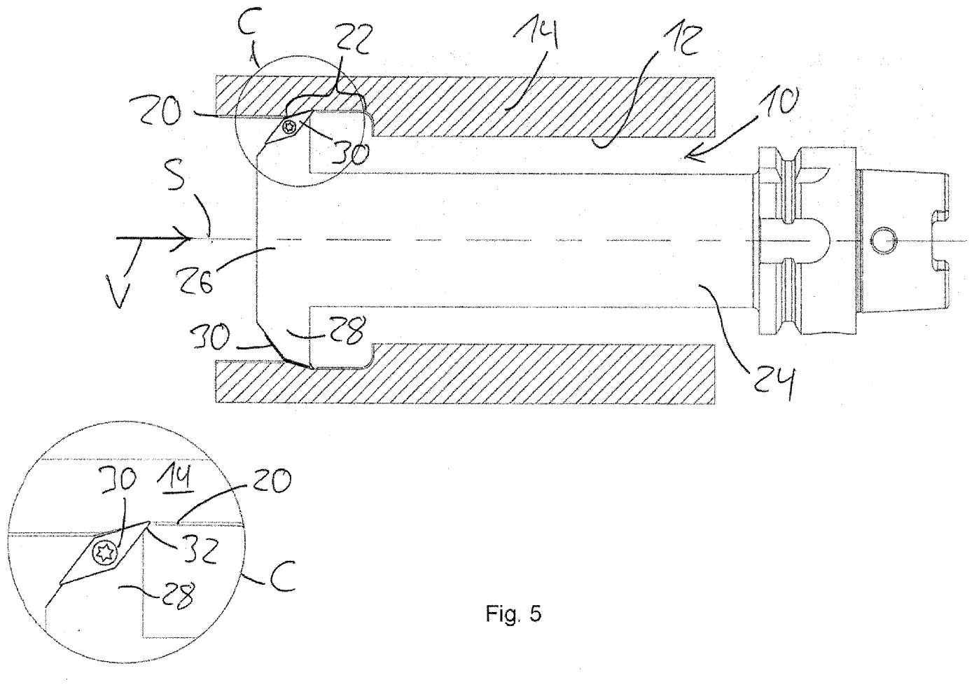

In step 5 (FIG. 5), the spindle 24 is rotated with the workpiece holder 26 and the clamping jaws 28 are extended or driven out radially, so that the cutting inserts 30 with their cutting edges 32 dip into the previously ground chamfer or annular groove 18.

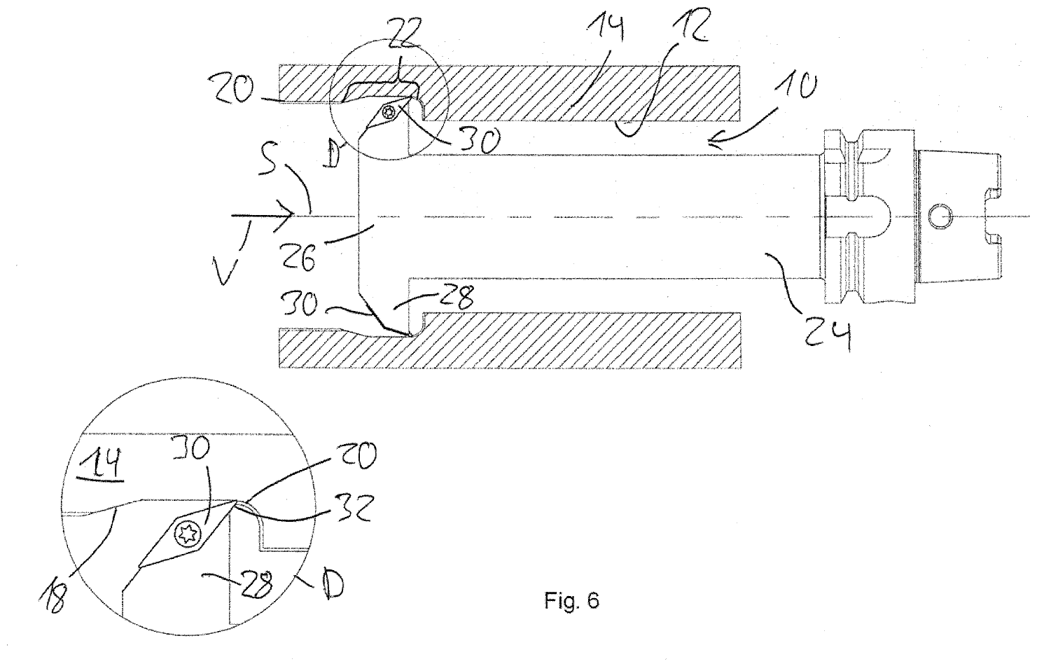

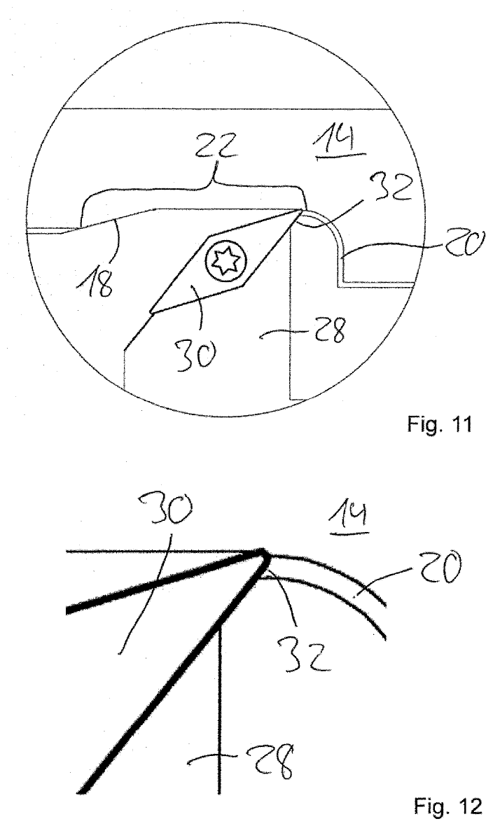

In step 6 (FIG. 6), the rotating workpiece holder 26 is moved in the direction of advancement V along the axis of rotation or symmetry S. The cutting edges 32 of the cutting inserts 30 thereby undercut the coating 20 and remove it laterally, which is also illustrated in detail in FIGS. 11 and 12. A thin layer of the substrate, that is, the crankcase 14, is also removed. The removal of the coating 20 by one of the cutting edges 32 is illustrated enlarged in FIGS. 10 and 11.

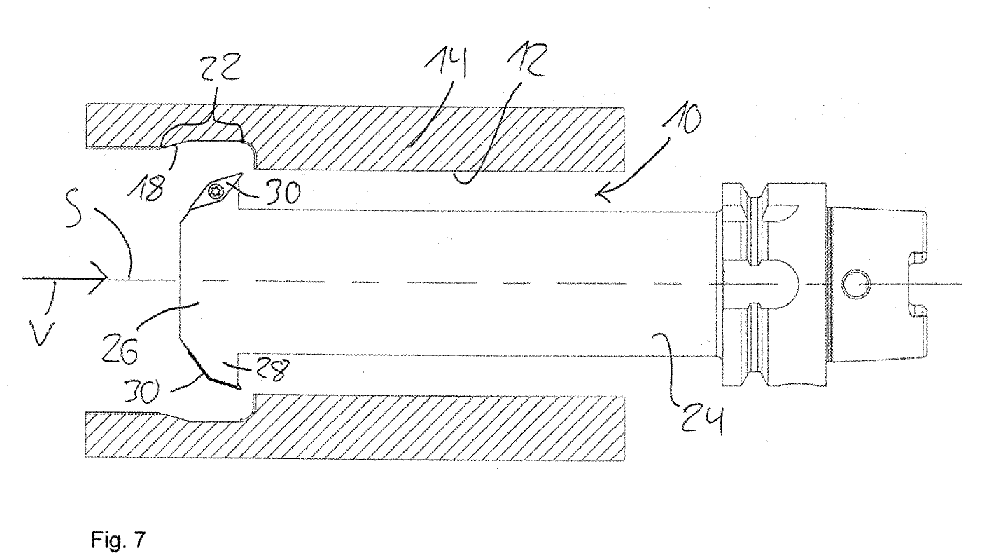

In step 7 (FIG. 7), the clamping jaws 28 are radially retracted or driven into their starting positions. The workpiece holder 26 is extended out of the cylinder 10 in the direction of advancement V.

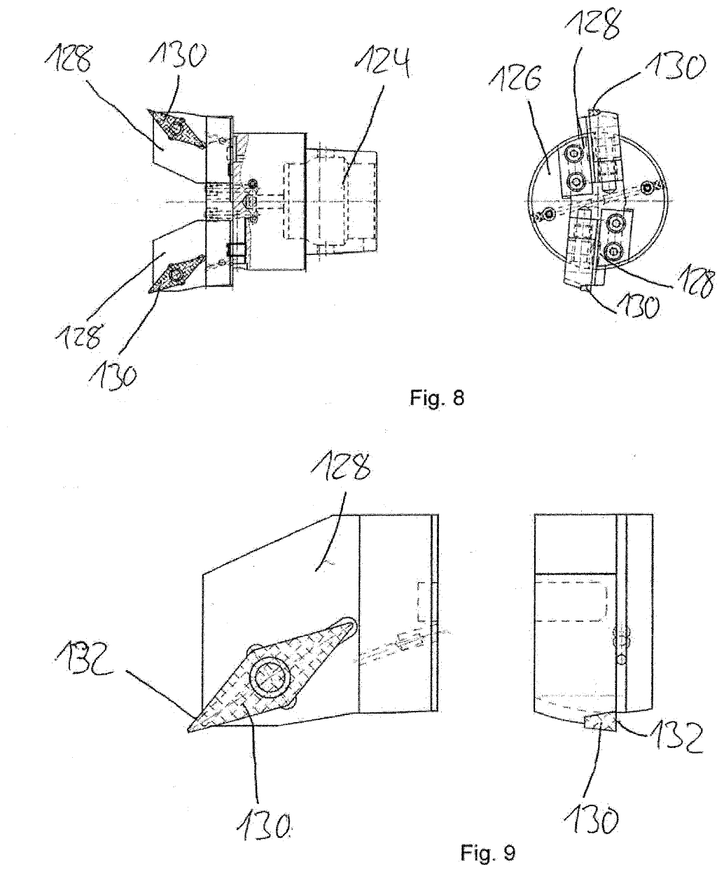

An alternative embodiment of a tool holder 126, which also has two radially adjustable clamping jaws 128, in which a respective cutting insert 130 with a cutting edge 132 is held as a machining tool, is shown in FIGS. 8 and 9. While in the tool holder 26, the cutting inserts 30 are arranged on a side of the tool holder 26 facing the spindle 24, the cutting inserts 130 in the tool holder 126 according to FIGS. 8 and 9 the cutting inserts 130 are arranged on the side facing away from a spindle 124, so that depending on the application, the coating 20 can be removed in a direction of advancement which is opposite to the direction of advancement V of FIGS. 1 to 7.

The tool holder 26 or 126 can advantageously have internal cooling, in which coolant is supplied to the cutting inserts 30, 130 via coolant channels provided in the interior of the spindle 24, 124 and the tool holder 26, 126.

The tool arrangement and the geometry of the cutting insert are illustrated in detail in FIGS. 10 to 12.

### REFERENCE LIST

10 cylinder
12 cylinder wall
14 crankcase, substrate
16 grinding tool
18 annular groove
20 coating
22 partial region
24, 124 spindle
26, 126 tool holder
28, 128 clamping jaw
30, 130 cutting insert
32, 132 cutting edge

1. A method for removing a partial region of a coating from a substrate, wherein the partial region to be removed is removed by a machining process such that the partial region of the coating to be removed is undercut, wherein to undercut the partial region of the coating to be removed, at least one machining tool rotating relative to the substrate about an axis of rotation is moved relative to the substrate along a direction of advancement (V) which runs parallel to a surface having the coating, wherein together with the coating, a substrate layer directly adjacent to the coating is also removed and the tool, considered in the direction of advancement (V), penetrates deeper into the substrate than into the coating to be removed.

2. The method according to claim 1, wherein the machining tool is a cutting insert.

3. The method according to claim 1, wherein the direction of advancement (V) further runs parallel to the axis of rotation.

4. The method according to claim 1, wherein the substrate is a cylinder wall of a cylinder of a crankcase, wherein the direction of advancement (V) runs in the axial direction of the cylinder.

5. The method according to claim 1, wherein the tool is held on a rotating spindle.

6. The method according to claim 1, wherein the tool is mounted in a non-rotating manner and the substrate is rotated.

7. The method according to claim 1, wherein the tool is adjustable along the direction of advancement (V).

8. The method according to claim 1, wherein the substrate is adjustable along the direction of advancement (V).

9. The method according to claim 1, wherein the tool is held such that a cutting edge of the tool provided for removing the coating runs obliquely to the direction of advancement (V).

10. The method according to claim 1, wherein the removal of the partial region of the coating comprises a generation of a groove free of undercuts, in a partial section of the partial region of the coating to be removed, wherein the groove is generated using a tool other than the tool provided for undercutting the partial region of the coating to be removed.

11. A chipping tool, for performing a method according to claim 1, comprising a tool holder fastened to a spindle, which tool holder has at least one radially opposite cutting edge, which cutting edges are radially adjustable.

12. The method according to claim 9, wherein the tool is held such that a cutting edge of the tool provided for removing the coating runs at an angle of 30° to 60° to the direction of advancement (V).

13. The method according to claim 10, wherein the removal of the partial region of the coating comprises a generation of an annular groove.

14. The method according to claim 11, wherein the chipping tool is a grinding tool.

15. The method according to claim 11, wherein the tool holder has two radially opposite cutting edges.

16. The method according to claim 11, wherein the radially opposite cutting edge is a cutting edge arranged on a cutting insert.
